(19) United States
(12) Patent Application Publication
(10) Pub. No.: US 2014/0286814 A1
(43) Pub. Date: Sep. 25, 2014

(54) COMPOSITE MAGNETIC MATERIAL, BURIED-COIL MAGNETIC ELEMENT USING SAME, AND METHOD FOR PRODUCING SAME

(71) Applicant: PANASONIC CORPORATION, Osaka (JP)

(72) Inventors: Junichi Kotani, Hyogo (JP); Nobuya Matsutani, Osaka (JP)

(21) Appl. No.: 14/349,300

(22) PCT Filed: Nov. 14, 2012
(86) PCT No.: PCT/JP2012/007299

§ 371 Date: Apr. 2, 2014

(30) Foreign Application Priority Data
Nov. 18, 2011 (JP) 2011-252559

(51) Int. Cl. H01F 1/22; H01F 41/02

(52) U.S. Cl. CPC H01F 1/22; H01F 41/02
USPC 419/30; 75/228

(57) ABSTRACT

A composite magnetic material includes metal magnetic powder and thermosetting resin. The metal magnetic powder includes first metal magnetic powder and second metal magnetic powder. The first metal magnetic powder includes iron and a first element with oxygen affinity higher than that of iron. The second metal magnetic powder includes at least iron. The second metal magnetic powder also includes the first element for an amount smaller than the first element contained in the first metal magnetic powder, or not include the first element. A mean particle diameter of the first metal magnetic powder is greater than a mean particle diameter of the second metal magnetic powder. The second metal magnetic powder is 10 weight % to 30 weight % of the total amount of the metal magnetic powder. This composite magnetic material can secure high magnetic permeability and also improve withstand voltage.

### TECHNICAL FIELD

The present invention relates to composite magnetic materials typically used for inductors, choke coils, and transformers; magnetic elements using same, and methods for producing same.

### BACKGROUND ART

In line with the recent trend of smaller and shorter electronics, there have also been increasing demands for smaller and shorter electronic components and devices used in these electronics. On the other hand, LSIs, such as CPUs, are becoming faster and higher density integration. In some cases, several amps to several tens of amps of current are supplied to power circuits for these LSIs. Therefore, smaller magnetic elements that suppress reduction of inductance due to DC superimposition are also demanded for use in these components. Furthermore, higher working frequency also requires low loss in a high-frequency region.

A powder magnetic core manufactured by compression-molding metal magnetic powder has good DC superimposition characteristics, and can thus support large current and allow downsizing. A buried-coil magnetic element is known as an element using this powder magnetic core.

A conventional buried-coil magnetic element is manufactured by embedding and compression-molding at least a part of a terminal and air core coil in a composite magnetic material made mainly of metal magnetic powder, thermosetting resin, and inorganic insulating material.

Compared to an assembly-type magnetic element manufactured by assembling a coil and powder magnetic core made of composite magnetic material, aforementioned buried-coil magnetic element can make a dead space, such as allowance in assembly dimensions, filled with the composite magnetic material. Therefore, a magnetic path length can be shortened and a cross-sectional area of magnetic path can be broadened. This is advantageous for downsizing and thinning the element.

PTL1 is one known prior art related to the present invention.

In addition, the use of two types of metal magnetic powder with different mean particle diameters for improving magnetic permeability can improve the filling rate. For example, PTL 2 is known for this composition.

### CITATION LIST

### Patent Literature

PTL1 Japanese Patent Unexamined Publication No. 2002-305108

PTL2 Publication of US Patent Application No. 2010/0289609

### SUMMARY OF THE INVENTION

Withstand voltage is a disadvantage of a conventional magnetic element.

More specifically, since at least a part of a terminal and an air-core coil are buried in a composite magnetic material, short-circuiting is triggered in the composite magnetic material if insulation breakdown of the composite magnetic material occurs at applying voltage between terminals. Therefore, a task of the composite magnetic material is to secure withstand voltage needed for the purpose of use of the buried-coil magnetic element. Withstand voltage is a value obtained by dividing voltage that does not cause insulation breakdown of test piece by distance where voltage is applied to the test piece. Withstand voltage of the test piece can be improved by extending the distance where voltage is applied. However, this is not preferable because it results in a larger magnetic element. Alternatively, withstand voltage can also be secured by increasing a mixed quantity of thermosetting resin. However, this may decrease magnetic permeability. A decrease in magnetic permeability results in lower inductance of the magnetic element. Inductance can be increased by increasing the number of copper coil windings of the magnetic element. However, DC current loss increases due to increased number of copper coil windings, resulting in reducing circuit efficiency. Reduction of magnetic permeability is thus not preferable.

The present invention aims to downsize a magnetic element, secure magnetic permeability, and improve withstand voltage.

The present invention includes a composite magnetic material of metal magnetic powder and thermosetting resin. The metal magnetic powder includes first metal magnetic powder and second metal magnetic powder. The first metal magnetic powder includes iron and a first element with oxygen affinity higher than that of iron. The second metal magnetic powder includes at least iron and also includes the first element for an amount smaller than that contained in the first metal magnetic powder. Or, the second metal magnetic powder does not include the first element. A mean particle diameter of the first metal magnetic powder is greater than a mean particle diameter of the second metal magnetic powder. In addition, the second metal magnetic powder is from 10% by weight to 30% by weight of the total amount of metal magnetic powder.

This composite magnetic material with the above composition enables to offer the composite magnetic material with high permeability and good withstand voltage. Accordingly, a buried-coil magnetic element manufactured using this composite magnetic material can be downsized, achieve high magnetic permeability, and improve withstand voltage.

### BRIEF DESCRIPTION OF DRAWINGS

FIG. 1 is a schematic view of a composite magnetic material in an exemplary embodiment of the present invention.

FIG. 2 is a schematic view of a composite magnetic material of first metal magnetic powder and thermosetting resin in the exemplary embodiment.

FIG. 3 is a schematic view of a composite magnetic material of second metal magnetic powder and thermosetting resin.

FIG. 4 is a perspective view of a buried-coil magnetic element in accordance with the exemplary embodiment.

FIG. 5 is a sectional view of the buried-coil magnetic element in FIG. 4 taken along line 5-5 in the exemplary embodiment.

FIG. 6 is a table of experiment results of specimen Nos. 1 to 18 in the exemplary embodiment.

FIG. 7 is a table experiment results of specimen Nos. 19 to 28 in the exemplary embodiment.

FIG. 8 is a table of experiment results of specimen Nos. 29 to 38 in the exemplary embodiment.

FIG. 9 is a table of experiment results of specimen Nos. 39 to 48 in the exemplary embodiment.

### DESCRIPTION OF EMBODIMENTS

### First Exemplary Embodiment

High magnetic permeability can be secured by using a composite magnetic material of two types of metal powder with different mean particle diameters. This is because second metal magnetic powder with small mean particle diameter enters a space formed between first metal magnetic powder particles with large mean particle diameter, and thus a filling rate of the metal magnetic material can be improved. As a result, high magnetic permeability can be achieved. However, since the distance between metal magnetic powder particles becomes shorter, withstand voltage of the composite magnetic material reduces. The inventor has focused on this phenomenon, and invented a composite magnetic material with high magnetic permeability and also high withstand voltage.

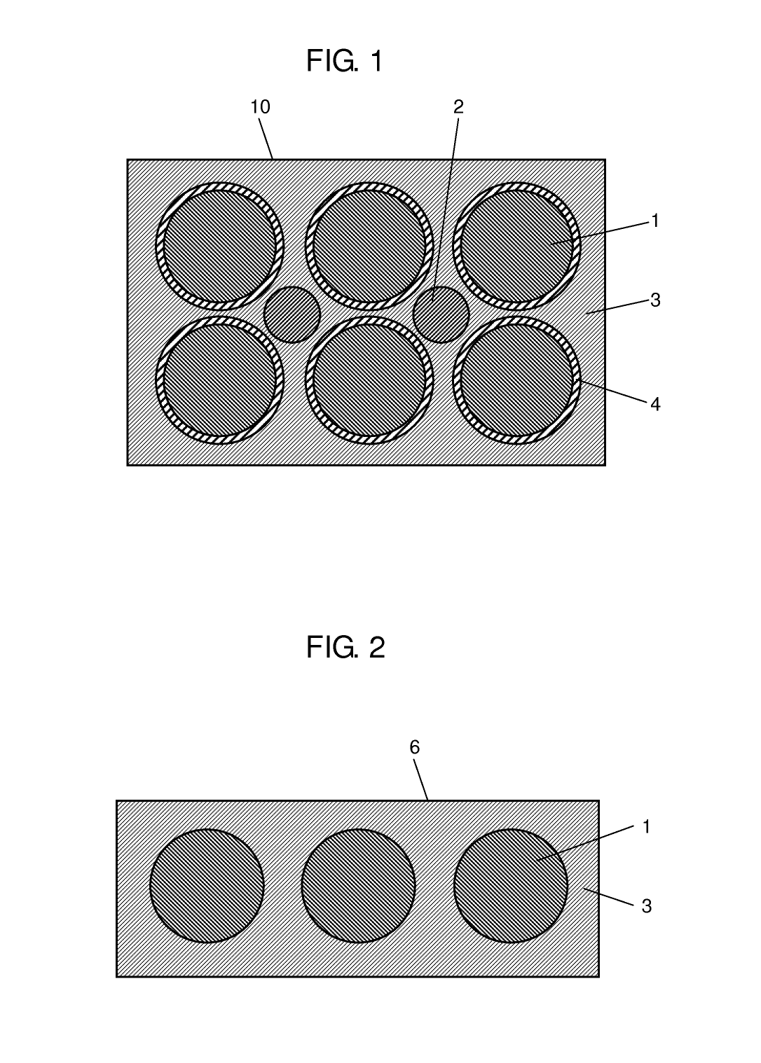

FIG. 1 is a schematic view of the composite magnetic material in the exemplary embodiment. As shown in FIG. 1, composite magnetic material 10 includes first metal magnetic powder 1, second metal magnetic powder 2, thermosetting resin 3, and oxide film 4.

The exemplary embodiment for improving withstand voltage and an influence of the mean particle diameter of metal magnetic powder on withstand voltage are described below.

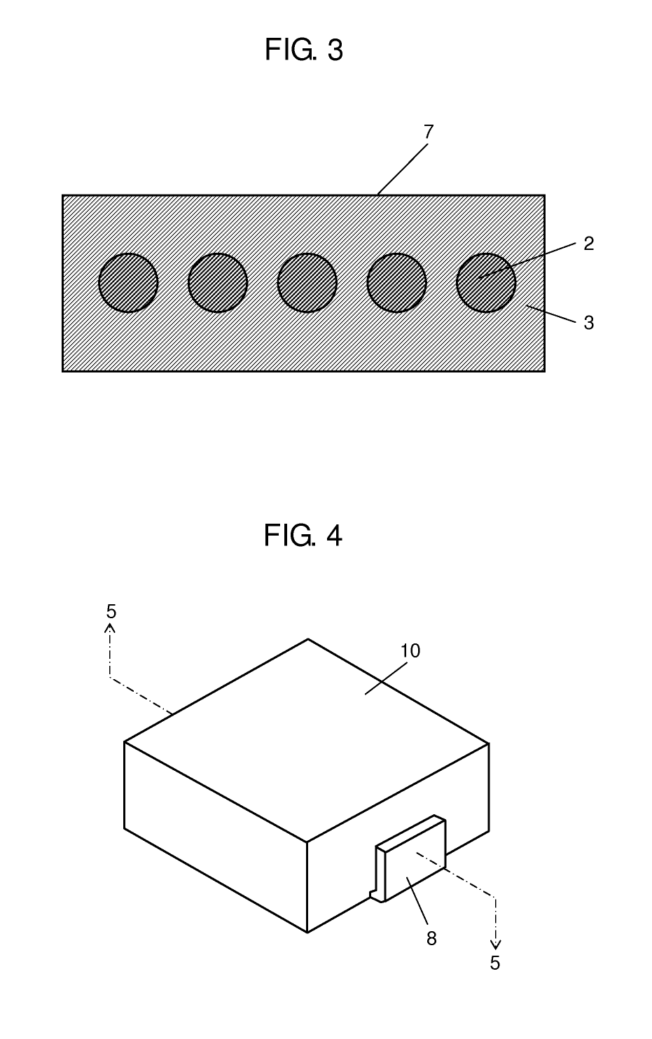

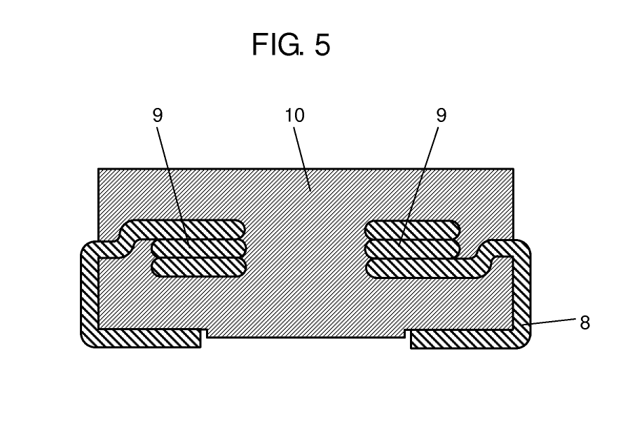

Composite magnetic material 6 shown in FIG. 2 includes first metal magnetic powder 1 with large mean particle diameter and thermosetting resin 3. Composite magnetic material 7 in FIG. 3 includes second metal magnetic powder 2 with mean particle diameter smaller than that of first metal magnetic powder 1 and thermosetting resin 3. When comparing these composite magnetic material 6 and composite magnetic material 7, an amount of resin between where voltage is applied is smaller in composite magnetic material 6. Withstand voltage of composite magnetic material 6 is thus lower. In other words, when metal magnetic powder with multiple mean particle diameters is used, first metal magnetic powder 1 with large mean particle diameter has larger influence on reduction of withstand voltage. Therefore, in the exemplary embodiment, the surface of first metal magnetic powder 1 with large mean particle diameter is covered with oxide film 4 to enable improvement of withstand voltage of composite magnetic material 10.

As an example of composition of first metal magnetic powder 1 to form the oxide film on its surface, the oxide film is formed on the surface as long as the first metal magnetic powder contains iron and the first element with oxygen affinity higher than that of iron.

The oxide film formed on the surface of first metal magnetic powder 1 is preferably not less than 10 nm and not greater than 50 nm. A film of 10 nm or more can improve withstand voltage, and a film of 50 nm or less can suppress reduction of magnetic permeability. Oxide film 4 can be formed by thermal treatment in the air.

First metal magnetic powder 1 in the exemplary embodiment is preferably Fe—Si—Al, Fe—Si, or Fe—Si—Cr based metal magnetic powder that is iron-base metal magnetic powder whose major component is iron. The iron-base metal magnetic powder has high saturated magnetic flux density, and thus is effective for the use at large current.

When Fe—Si—Al based metal magnetic powder is used, their proportions are preferably 8 to 12 weight % for Si, 4 to 6 weight % for Al, and remaining for Fe and unavoidable impurities. Unavoidable impurities refer to composition that is not intended on manufacturing, including Mn, Cr, Ni, P, S, and C. By setting the above composition range for the content of each constituent element, high magnetic permeability and low magnetic coercive force are achieved.

When Fe—Si based metal magnetic powder is used, their proportions are preferably 1 to 8 weight % for Si, and remaining for Fe and unavoidable impurities. Same as above, unavoidable impurities are Mn, CR, Ni, P, S, and C. Si in the metal magnetic powder has an effect of decreasing magnetic anisotropy and magnetostriction constant, increasing electric resistance, and reducing eddy-current loss. Mixing of Si for 1 weight % or more can improve the soft magnetic property, and 8 weight % or less can suppress reduction of saturated magnetization to suppress reduction of DC superimposition characteristics.

When Fe—Si—Cr based metal magnetic powder is used, their proportions are preferably 1 to 8 weight % for Si, 2 to 8 weight % for Cr, and remaining for Fe and unavoidable impurities. Unavoidable impurities include Mn, Cr, Ni, P, S, and C.

The role of Si in the above material compositions is to decrease magnetic anisotropy and magnetostriction constant, increase electric resistance, and reduce eddy-current loss. Mixing of Si for 1 weight % or more can improve soft magnetic property, and 8 weight % or less can suppress reduction of saturated magnetization to suppress reduction of DC superimposition characteristics.

Cr in the metal magnetic powder can improve weather resistance. Mixing of Cr for 2 weight % or more can improve weather resistance, and 8 weight % or less can suppress degradation of the soft magnetic property.

Second metal magnetic powder 2 in the exemplary embodiment is preferably Fe or Fe—Ni based metal magnetic powder that is iron-base metal magnetic powder containing iron as a major component.

However, as long as second metal magnetic powder 2 is iron-base metal magnetic powder, it is not limited to Fe or Fe—Ni based metal magnetic powder in the exemplary embodiment. Second metal magnetic powder 2 may contain Fe in major proportions and unavoidable impurities. Unavoidable impurities include Mn, Cr, Ni, P, S, and C. By increasing the purity of Fe, a high saturated magnetic flux density can be obtained. Powder on which antioxidizing film is formed by using chemical method may also be used. For example, surface treatment by organic phosphoric acid can form the antioxidizing film.

When Fe—Ni based metal magnetic powder is used, their proportions are preferably 40 to 90 weight % for Ni and remaining for Fe and unavoidable impurities. Unavoidable impurities include Mn, Cr, Ni, P, S, and C.

The description below refers to an example of second metal magnetic powder that does not include an element (hereafter referred to as a first element) with oxygen affinity higher than that of iron in the first metal magnetic powder. However, as long as a content of the first element with oxygen affinity higher than that of iron is less than a content of the first element contained in the first metal magnetic powder, there is no problem. In other words, experiments use an example of the second metal magnetic powder containing zero amount of the first element.

As for the role of Ni content, there is less effect of improving soft magnetic property if Ni content is 40 weight % or less. If the Ni content is 90 weight % or more, saturated magnetization significantly reduces, and thus the DC superimposition characteristics degrade. To further improve the magnetic permeability, 1 to 6 weight % of Mo may be added.

As for Vickers hardness of the iron-base metal magnetic powder, Vickers hardness of first metal magnetic powder 1 is preferably 300 Hv to 700 Hv. Vickers hardness of second metal magnetic powder 2 is preferably 100 Hv to 180 Hv. By adjusting to these levels of Vickers hardness, the filling rate of metal magnetic powder can be increased. More specifically, the filling rate of metal magnetic powder can be increased if first metal magnetic powder 1 with large mean particle diameter is harder and second metal magnetic powder 2 with small mean particle diameter is softer.

As for the mean particle diameter of iron-base metal magnetic powder, the mean particle diameter of first metal magnetic powder 1 is 5 μm to 30 μm, and the mean particle diameter of second metal magnetic powder 2 is 1 μm to 15 μm. The mean particle diameter of second metal magnetic powder 2 is preferably ½ or less than that of first metal magnetic powder 1. These mean particle diameters enable to secure high filling rate in the compression-molded powder magnetic core. In addition, by adjusting the mean particle diameter of first metal magnetic powder 1 to 30 μm or less, an increase of eddy-current loss in a high-frequency region can be suppressed. By mixing these first metal magnetic powder 1 and second metal magnetic powder 2, composite magnetic material 10 will have high magnetic permeability, improving withstand voltage.

The mean particle diameter is measured using the laser diffraction and scattering method.

Thermosetting resin 3 used in the present invention is typically epoxy resin, phenol resin, polyimide resin, or silicone resin. Thermosetting resin whose base resin is liquid at ordinary temperature is preferable. A small amount of dispersant may be added to improve dispersiveness of thermosetting resin 3 and metal magnetic powder.

Next, a method for producing aforementioned composite magnetic material 10 is described.

Firstly, first metal magnetic powder 1 as iron-base metal magnetic powder, second metal magnetic powder 2, uncured thermosetting resin 3, and a material containing inorganic insulant are mixed and dispersed to prepare a mixture. This mixture is heated at between 65° C. and 150° C. to evaporate solvent and obtain composite magnetic material 10 with good moldability.

Equipment for preparing the composite magnetic material of the present invention by dispersing the metal magnetic powder and inorganic insulant is mainly a ball mill. However, the same effect can be expected even if equipment other than the ball mill, such as V-type mixer and cross rotary, is used.

Moldability can be further improved by adding a process to classify and granulate aforementioned composite magnetic material 10 containing uncured thermosetting resin after solvent is evaporated.

Next, composite magnetic material 10 is compression-molded such that coil 9 and at least a part of a pair of terminals 8 electrically connected to coil 9 are embedded to obtain a molded piece. This achieves a structure with less dead space. Accordingly, the length of magnetic path can be shortened and a cross sectional area of magnetic path can be broadened.

Then, the molded piece is heated at between 150° C. and 250° C. to sufficiently cure thermosetting resin 3.

### First Experiment

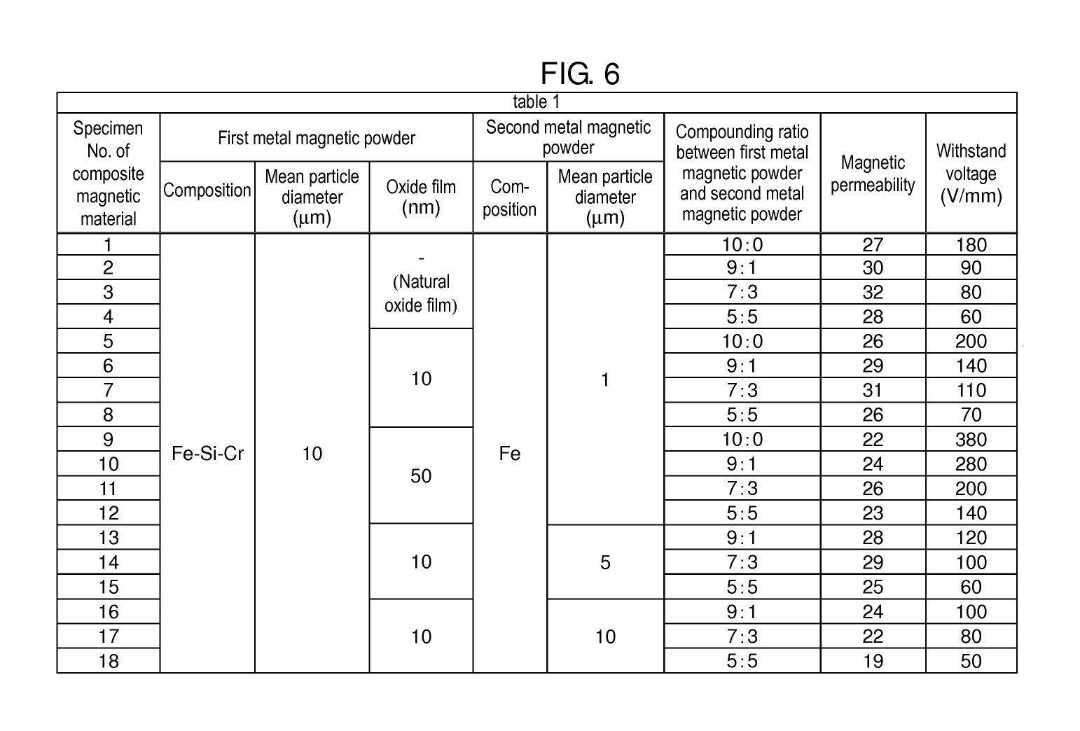

The composite magnetic material in the exemplary embodiment is used in the first experiment. FIG. 6 shows results of the first experiment using specimen Nos. 1 to 18 (table in FIG. 6 is hereinafter referred to as Table 1).

In the first experiment, first metal magnetic powder 1 is Fe—Si—Cr based metal magnetic powder with mean particle diameter of 10 μm, and second metal magnetic powder 2 is iron metal magnetic powder with mean particle diameter of 1 μm, 5 μm and 10 μm. A mixture is prepared by mixing 3 g of silicone resin as thermosetting resin 3 to 100 g of this iron-base metal magnetic powder. For first metal magnetic powder 1, one on which oxide film 4 is formed at ordinary temperature in the air and one on which oxide film 4 is intentionally formed at high temperature in the air are used. Vickers hardness of first metal magnetic powder 1 is 300 Hv, and Vickers hardness of second metal magnetic powder 2 is 100 Hv in the first experiment. The mixture prepared as above is used for preparing a molded piece by compression-molding with molding pressure of 4 ton/cm² at room temperature. Then, thermal curing is applied for two hours at 150° C. to prepare a test piece. Dimensions of test piece are 10 mm×10 mm×0.5 mm, and voltage is applied across this 0.5-mm side to measure and evaluate insulation resistance rate and withstand voltage.

FIG. 6 shows results of the first experiment. The buried-coil magnetic element requires 100 V/mm or more as withstand voltage.

Specimen Nos. 2 to No. 4 use first metal magnetic powder 1 with mean particle diameter of 10 μm on which only a natural oxide film is formed without oxide film 4 and second metal magnetic powder 2 with mean particle diameter of 1 μm. Composite magnetic materials 10 using these specimens have low withstand voltage, and thus they cannot be used.

Specimen No. 5 only uses first metal magnetic powder 1 with mean particle diameter 10 μm on which 10 nm of oxide film 4 is intentionally formed at high temperature in the air. Specimen Nos. 6 and 7 use first metal magnetic powder 1 with mean particle diameter of 10 μm on which 10 nm of oxide film 4 is intentionally formed at high temperature in the air and second metal magnetic powder 2 with mean particle diameter of 1 μm. In specimen Nos. 6 and 7, the compounding ratio of second metal magnetic powder 2 to the total amount of first metal magnetic powder is 10 wt % and 30 wt %, respectively. These specimens can secure magnetic permeability and withstand voltage. On the other hand, specimen No. 8 in which the compounding ratio of second metal magnetic powder 2 is 50 wt % to the total amount of first metal magnetic powder shows no improvement in magnetic permeability, and withstand voltage is also low. Specimen No. 8 thus cannot be used. Specimen No. 9 only uses first metal magnetic powder with mean particle diameter of 10 μm on which 50 nm of oxide film 4 is intentionally formed at high temperature in the air. Its magnetic permeability is low, and the number of windings of the coil needs to be increased in order to obtain inductance same as that of Specimen No. 1. This increases DC resistance and causes large heat generation at operating the circuit. Accordingly, a decrease in magnetic permeability is preferably suppressed to 10% or less.

Specimen Nos. 10 and 11 use first metal magnetic powder 1 with mean particle diameter of 10 μm on which 50 nm of oxide film 4 is intentionally formed at high temperature in the air, and second metal magnetic powder 2 with mean particle diameter of 1 μm. In Specimen Nos. 10 and 11, the compounding ratio of second metal magnetic powder 2 to the total amount of first metal magnetic powder 1 is 10 wt % and 30 wt %, respectively. These specimens can secure magnetic permeability and withstand voltage. On the other hand, Specimen No. 12 in which the compounding ratio of second metal magnetic powder 2 to the total amount of first metal magnetic powder 1 is 50 wt % shows no improvement in magnetic permeability. The number of coil windings needs to be increased to obtain inductance same as that of Specimen No. 1. This increases DC resistance and causes large heat generation at operating the circuit. Accordingly, a decrease in magnetic permeability is preferably suppressed to 10% or less.

Specimen Nos. 13 and 14 use first metal magnetic powder 1 with mean particle diameter of 10 μm on which 10 nm of oxide film 4 is intentionally formed at high temperature in the air, and second metal magnetic powder 2 with mean particle diameter of 5 μm. In these Specimen Nos. 13 and 14, the compounding ratio of second metal magnetic powder 2 to the total amount of first metal magnetic powder 1 is 10 wt % and 30 wt %, respectively. These specimens can secure magnetic permeability and withstand voltage. On the other hand, composite magnetic material 10 using specimen No. 15 in which the compounding ratio of second metal magnetic powder 2 to the total amount of first metal magnetic powder 1 is 50 wt % shows low withstand voltage, and thus it cannot be used.

Specimen Nos. 16 to 18 use first metal magnetic powder 1 with mean particle diameter of 10 μm on which 10 nm of oxide film 4 is intentionally formed at high temperature in the air, and second metal magnetic powder 2 with mean particle diameter of 10 μm. Composite magnetic materials 10 using these specimens show low magnetic permeability or withstand voltage, and thus they cannot be used.

### Second Experiment

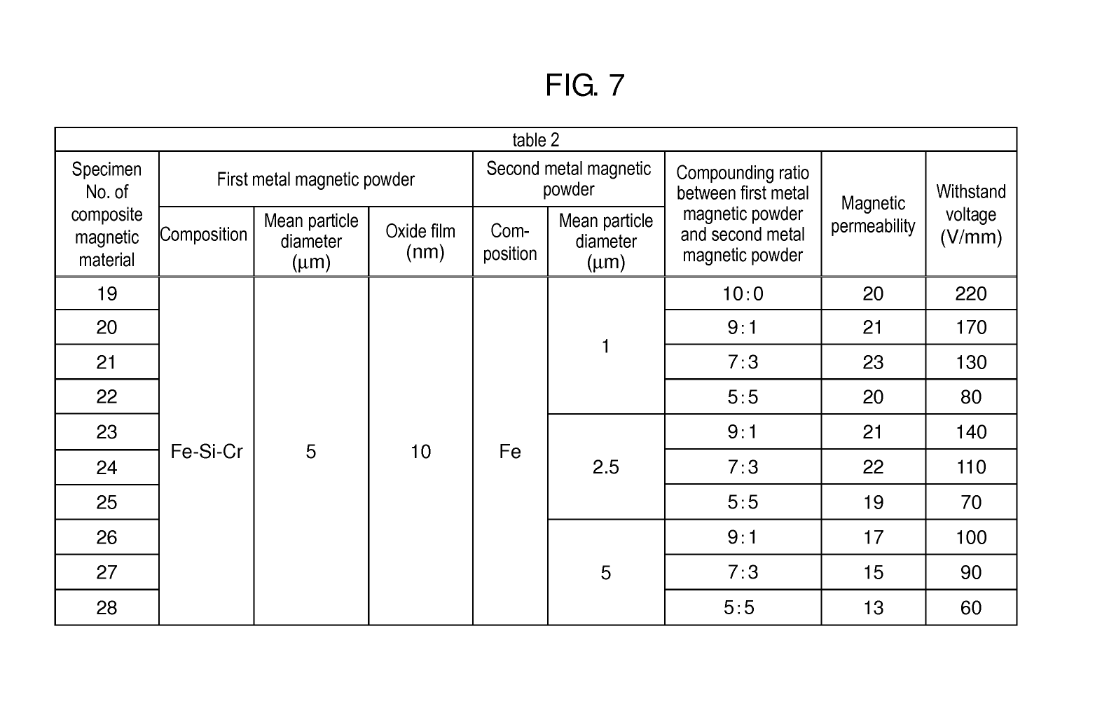

The second experiment uses a composite magnetic material in the exemplary embodiment same as the first experiment. FIG. 7 shows results of the second experiment using Specimen Nos. 19 to 28 (table in FIG. 7 is hereinafter referred to as Table 2).

In the second experiment, first metal magnetic powder 1 is Fe—Si—Cr based metal magnetic powder with mean particle diameter of 5 μm, and second metal magnetic powder 2 is iron metal magnetic powder with mean particle diameter of 1 μm, 2.5 μm and 5 μm. A mixture is prepared by mixing 3 g of silicone resin as thermosetting resin 3 to 100 g of this iron-base metal magnetic powder. For first metal magnetic powder 1, one on which oxide film 4 is formed at ordinary temperature in the air and one on which oxide film 4 is intentionally formed at high temperature in the air are used. Vickers hardness of first metal magnetic powder 1 and second metal magnetic powder 2 is the same as that indicated in the results of the first experiment, regardless of mean particle diameters of materials. This mixture is compression-molded by applying molding pressure of 4 ton/cm² at ordinary temperature to prepare a molded piece. Then, thermal curing is applied for two hours at 150° to prepare a test piece. Dimensions of the test piece are 10 mm×10 mm×0.5 mm, and voltage is applied across this 0.5-mm side to measure and evaluate insulation resistance rate and withstand voltage.

FIG. 7 shows the results of the second experiment. The buried-coil magnetic element requires 100 V/mm or more as withstand voltage. In the second experiment, Specimen No. 19 is a reference piece.

Specimen Nos. 20 and 21 use first metal magnetic powder 1 with mean particle diameter of 5 μm on which 10 nm of oxide film 4 is intentionally formed at high temperature in the air, and second metal magnetic powder 2 with mean particle diameter of 1 μm. In Specimen Nos. 20 and 21, the compounding ratio of second metal magnetic powder 2 to the total amount of first metal magnetic powder 1 is 10 wt % and 30 wt %, respectively. These specimens can secure magnetic permeability and withstand voltage. On the other hand, composite magnetic material 10 using Specimen No. 22 in which the compounding ratio of second metal magnetic powder 2 to the total amount of first metal magnetic powder 1 is 50 wt % shows low withstand voltage, and thus it cannot be used.

Specimen Nos. 23 and 24 use first metal magnetic powder 1 with mean particle diameter of 5 μm on which 10 nm of oxide film 4 is intentionally formed at high temperature in the air, and second metal magnetic powder with mean particle diameter of 2.5 μm. In Specimen Nos. 23 and 24, the compounding ratio of second metal magnetic powder to the total amount of first metal magnetic powder 1 is 10 wt % and 30 wt %, respectively. These specimens can secure magnetic permeability and withstand voltage. However, composite magnetic material 10 using specimen No. 25 in which the compounding ratio of second metal magnetic powder 2 is 50 wt % to the total amount of first metal magnetic powder 1 has low withstand voltage, and thus it cannot be used.

Specimen Nos. 26 to 28 use first metal magnetic powder 1 with mean particle diameter of 5 μm on which 10 nm of oxide film 4 is formed, and second metal magnetic powder 2 with mean particle diameter of 10 μm. Composite magnetic materials 10 using these specimens show low magnetic permeability and withstand voltage, and thus they cannot be used.

### Third Experiment

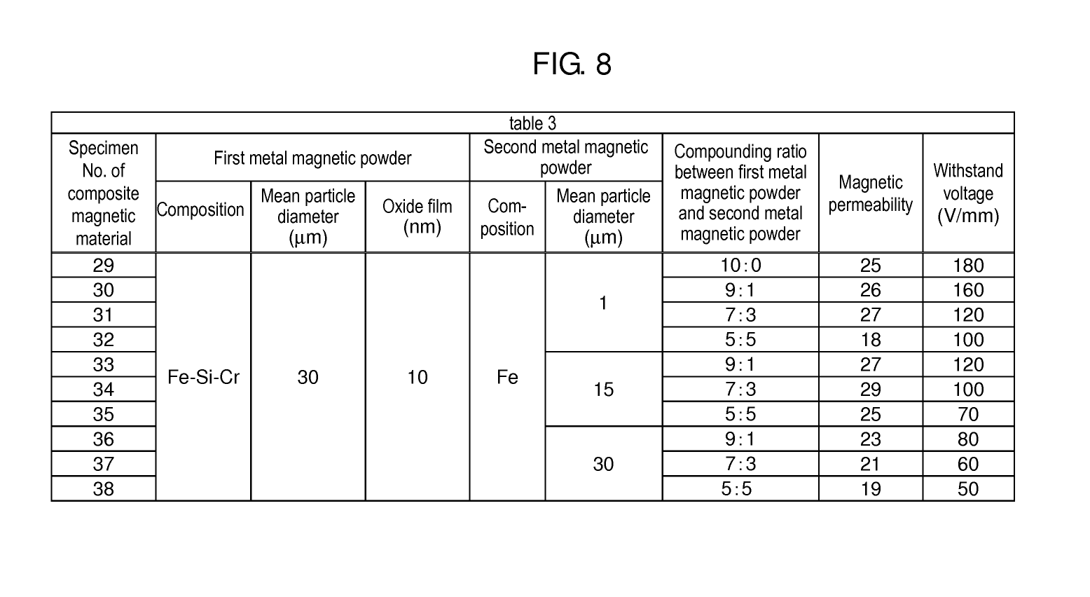

The third experiment uses the composite magnetic material in the exemplary embodiment same as the first experiment. FIG. 8 shows results of the third experiment using Specimen Nos. 29 to 39 (table in FIG. 8 is hereinafter referred to as Table 3).

In the third experiment, first metal magnetic powder 1 is Fe—Si—Cr based metal magnetic powder with mean particle diameter of 30 μm, and second metal magnetic powder 2 is iron metal magnetic powder with mean particle diameter of 1 μm, 15 μm and 30 μm. A mixture is prepared by mixing 3 g of silicone resin as thermosetting resin 3 to 100 g of this iron-base metal magnetic powder. For first metal magnetic powder 1, one on which oxide film 4 is formed at ordinary temperature in the air and one on which oxide film 4 is intentionally formed at high temperature in the air are used. Vickers hardness of first metal magnetic powder 1 and second metal magnetic powder 2 is the same as that indicated in the results of the first experiment in FIG. 6, regardless of the mean particle diameter of material. The mixture obtained in the above way is compression-molded by applying molding-pressure of 4 ton/cm² at ordinary temperature to prepare a molded piece. Then, thermal curing is applied for two hours at 150° to prepare a test piece. Dimensions of the test piece are 10 mm×10 mm×0.5 mm, and voltage is applied across this 0.5-mm side to measure and evaluate insulation resistance rate and withstand voltage.

FIG. 8 shows the results of the third experiment. In the third experiment, Specimen No. 29 is a reference piece.

The buried-coil magnetic element requires 100 V/mm or more as withstand voltage.

Specimen Nos. 30 and 31 use first metal magnetic powder 1 with mean particle diameter of 30 μm on which 10 nm of oxide film 4 is intentionally formed at high temperature in the air, and second metal magnetic powder 2 with mean particle diameter of 1 μm. In Specimen Nos. 30 and 31, the compounding ratio of second metal magnetic powder 2 to the total amount of first metal magnetic powder 1 is 10 wt % and 30 wt %, respectively. Composite magnetic materials 10 using these specimens can secure magnetic permeability and withstand voltage. On the other hand, Specimen No. 32 in which the compounding ratio of second metal magnetic powder is 50 wt % to the total amount of first metal magnetic powder 1 shows no improvement in magnetic permeability. The number of coil windings needs to be increased to obtain inductance same as that of Specimen No. 29. This increases DC resistance, and causes large heat generation at operating the circuit. Accordingly, a decrease in magnetic permeability is preferably suppressed to 10% or less.

Specimen Nos. 33 and 34 use first metal magnetic powder with mean particle diameter of 30 μm on which 10 nm of oxide film 4 is intentionally formed at high temperature in the air, and second metal magnetic powder 2 with mean particle diameter of 15 μm. In these specimen Nos. 33 and 34, the compounding ratio of second metal magnetic powder 2 to the total amount of first metal magnetic powder 1 is 10 wt % and 30 wt %, respectively. Composite magnetic materials 10 using these specimens can secure magnetic permeability and withstand voltage.

On the other hand, composite magnetic material 10 using Specimen No. 35 in which the compounding ratio of second metal magnetic powder 2 to the total amount of first metal magnetic powder 1 is 50 wt % shows low withstand voltage, and thus it cannot be used.

Specimen Nos. 36 to 38 use first metal magnetic powder 1 with mean particle diameter of 30 μm on which 10 nm of oxide film 4 is intentionally formed at high temperature in the air, and second metal magnetic powder with mean particle diameter of 30 μm. Composite magnetic materials 10 using these specimens have low withstand voltage, and thus they cannot be used.

### Fourth Experiment

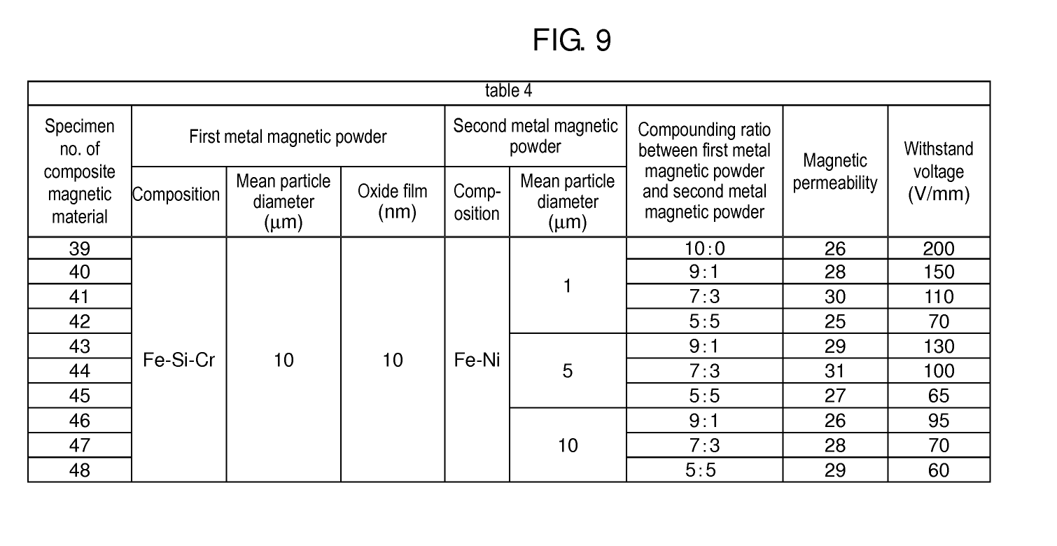

The fourth experiment uses the composite magnetic material in the exemplary embodiment same as the first experiment. FIG. 9 shows results of the fourth experiment using Specimen Nos. 39 to 48 (table in FIG. 9 is hereinafter referred to as Table 4).

In the fourth experiment, first metal magnetic powder 1 is Fe—Si—Cr based metal magnetic powder with mean particle diameter of 10 μm, and second metal magnetic powder 2 is Fe—Ni based metal magnetic powder with mean particle diameter of 1 μm, 5 μm and 10 μm. A mixture is prepared by mixing 6 g of silicone resin as thermosetting resin 3 to 100 g of this iron-base metal magnetic powder. For first metal magnetic powder 1, one on which oxide film 4 is formed at ordinary temperature in the air and one on which oxide film 4 is intentionally formed at high temperature in the air are used. Vickers hardness of first metal magnetic powder 1 is 300 Hv, and Vickers hardness of second metal magnetic powder 2 is 180 Hv in the experiment. The mixture as obtained in the above way is compression-molded by applying molding pressure of 4 ton/cm² at room temperature to prepare a molded piece. Then, thermal curing is applied for two hours at 150° to prepare a test piece. Dimensions of the test piece are 10 mm×10 mm×0.5 mm, and voltage is applied across this 0.5-mm side to measure and evaluate insulation resistance rate and withstand voltage.

FIG. 9 shows the results of the fourth experiment. In the fourth experiment, specimen No. 39 is a reference.

The buried-coil magnetic element requires 100 V/mm or more as withstand voltage.

Specimen Nos. 40 and 41 use first metal magnetic powder 1 with mean particle diameter of 10 μm on which 10 nm of oxide film 4 is formed, and second metal magnetic powder 2 with mean particle diameter of 1 μm. In Specimen Nos. 40 and 41, the compounding ratio of second metal magnetic powder to the total amount of the first metal magnetic powder 1 is 10 wt % and 30 wt %, respectively. Composite magnetic materials 10 using these specimens can secure magnetic permeability and withstand voltage. On the other hand, composite magnetic material 10 using Specimen No. 42 in which the compounding ratio of second metal magnetic powder 2 to the total amount of first metal magnetic powder 1 is 50 wt % shows no improvement in magnetic permeability. Withstand voltage is also low, and thus it cannot be used.

Specimen Nos. 43 and 44 use first metal magnetic powder 1 with mean particle diameter of 10 μm on which 10 nm of oxide film 4 is intentionally formed at high temperature in the air, and second metal magnetic powder 2 with mean particle diameter of 5 μm. In Specimen Nos. 43 and 44, the compounding ratio of second metal magnetic powder 2 to the total amount of first metal magnetic powder 1 is 10 wt % and 30 wt %, respectively. Composite magnetic materials 10 using these specimens can secure magnetic permeability and withstand voltage. On the other hand, composite magnetic material 10 using Specimen No. 45 in which the compounding ratio of second metal magnetic powder 2 to the total amount of first metal magnetic powder 1 is 50 wt % has low withstand voltage, and thus it cannot be used.

Specimen Nos. 46 to 48 use first metal magnetic powder 1 with mean particle diameter of 10 μm on which 10 nm of oxide film 4 is intentionally formed at high temperature in the air, and second metal magnetic powder 2 with mean particle diameter of 10 μm. Composite magnetic materials 10 using these specimens show low withstand voltage, and thus they cannot be used.

As described above, the exemplary embodiment offers composite magnetic material 10 that can improve withstand voltage, reduce the size, and secure high magnetic permeability.

Composite magnetic material 10 of the present invention can support large current and high frequencies, and reduce size. In addition, withstand voltage can be increased. Accordingly, the present invention is effectively applicable to a range of electronic devices.

### REFERENCE MARKS IN THE DRAWINGS

1 First metal magnetic powder
2 Second metal magnetic powder
3 Thermosetting resin
4 Oxide film
6 Composite magnetic material
7 Composite magnetic material
8 Pair of terminals
9 Coil
10 Composite magnetic material

1. A composite magnetic material comprising:
metal magnetic powder including first metal magnetic powder and second magnetic powder,
the first metal magnetic powder including iron and a first element having oxygen affinity higher than that of iron, and
the second metal magnetic powder including at least iron, and including either one of the first element in an amount smaller than an amount of the first element contained in the first metal magnetic powder or none of the first element; and
thermosetting resin,
wherein
a mean particle diameter of the first metal magnetic powder is greater than a mean particle diameter of the second metal magnetic powder, and
the second metal magnetic powder is not less than 10 weight % and not greater than 30 weight % of a total amount of the metal magnetic powder.

2. The composite magnetic material of claim 1, wherein a surface of the first metal magnetic powder is covered with an oxide film.

3. The composite magnetic material of claim 1, wherein the metal magnetic powder further includes third metal magnetic powder.

4. The composite magnetic material of claim 2, wherein a thickness of the oxide film on the first metal magnetic powder is not less than 10 nm and not greater than 50 nm.

5. The composite magnetic material of claim 1, wherein a surface of the second metal magnetic powder is covered with an anti-oxidizing film.

6. The composite magnetic material of claim 1,
wherein
Vickers hardness of the first metal magnetic powder is not less than 300 Hv, and
Vickers hardness of the second metal magnetic powder is not greater than 180 Hv.

7. The composite magnetic material of claim 1, wherein the first metal magnetic powder is one of Fe—Si—Al based, Fe—Si based, and Fe—Si—Cr based metal magnetic powder.

8. The composite magnetic material of claim 1,
wherein
the mean particle diameter of the first metal magnetic powder is not less than 5 μm and not greater than 30 μm, and
the mean particle diameter of the second metal magnetic powder is not less than 1 μm and not greater than 15 μm.

9. A buried-coil magnetic element using a composite magnetic material, the composite magnetic material comprising:
metal magnetic powder including first metal magnetic powder and second magnetic powder,
the first metal magnetic powder including iron and a first element having oxygen affinity higher than that of iron, and
the second metal magnetic powder including at least iron, and including either one of the first element in an amount smaller than an amount of the first element contained in the first metal magnetic powder or none of the first element; and
thermosetting resin,
wherein
a mean particle diameter of the first metal magnetic powder is greater than a mean particle diameter of the second metal magnetic powder, and
the second metal magnetic powder is not less than 10 weight % and not greater than 30 weight % of a total amount of the metal magnetic powder.

10. A method for producing a buried-coil magnetic element, comprising:
a first step of preparing a composite magnetic material by mixing metal magnetic powder mainly including iron and uncured thermosetting resin;
a second step of making a molded body by compression-molding the composite magnetic material such that a coil and at least a part of a pair of terminals electrically connected to the coil are embedded; and
a third step of curing the thermosetting resin by heating the composite magnetic material,
wherein
the composite magnetic material includes the metal magnetic powder and the thermosetting resin,
the metal magnetic powder includes first metal magnetic powder and second magnetic powder,
the first metal magnetic powder includes iron and a first element having oxygen affinity higher than that of iron,
the second metal magnetic powder includes at least iron, and includes either one of the first element in an amount smaller than an amount of the first element contained in the first metal magnetic powder or none of the first element,
a mean particle diameter of the first metal magnetic powder is greater than a mean particle diameter of the second metal magnetic powder, and
the second metal magnetic powder is not less than 10 weight % and not greater than 30 weight % of a total amount of the metal magnetic powder.

11. The method for producing the buried-coil magnetic element of claim 10, further comprising a fourth step of heating the composite magnetic material at not less than 65° C. and not greater than 150° C. between the first step and the second step.

12. The method for producing the buried-coil magnetic element of claim 10, further comprising a step of granulating the composite magnetic material between the first step and the second step.

13. The method for producing the buried-coil magnetic element of claim 11, further comprising a step of granulating the composite magnetic material between the first step and the fourth step.
